(19) United States
(12) Patent Application Publication
(10) Pub. No.: US 2026/0298232 A1
(43) Pub. Date: Oct. 1, 2026

(54) SCROLL COMPRESSOR

(71) Applicant: BITZER REFRIGERATION TECHNOLOGY (CHINA) CO., LTD., Beijing (CN)

(72) Inventors: Junliang PEI, Beijing (CN); Qing MIAO, Beijing (CN)

(21) Appl. No.: 18/880,370

(22) PCT Filed: Apr. 16, 2024
(86) PCT No.: PCT/CN2024/088035

§ 371 Date: Dec. 31, 2024

(30) Foreign Application Priority Data
Jun. 30, 2023 (CN) 202310798743.7

(51) Int. Cl. F04C 18/02; F04C 28/24

(52) U.S. Cl. CPC F04C 18/0215; F04C 28/24

(57) ABSTRACT

A scroll compressor includes a fix scroll, an orbiting scroll, a pressure partition plate, an upper cap, an exhaust valve, and a pressure relief valve. The orbiting scroll is configured to cooperate with the fix scroll to form a compression chamber with variable volume. The pressure partition plate is arranged on the fix scroll. The upper cap is connected to the pressure partition plate to form an exhaust chamber. The exhaust valve is configured to connect the compression chamber with the exhaust chamber in a case that the exhaust pressure of the compressor is reached. The pressure relief valve is arranged on the pressure partition plate and is configured to connect the compression chamber with the exhaust chamber in a case that the pressure in the compression chamber exceeds the exhaust pressure.

The present disclosure claims priority to Chinese Patent Application No. 202310798743.7, titled “SCROLL COMPRESSOR”, filed on Jun. 30, 2023 with the National Intellectual Property Administration, PRC, which is incorporated herein by reference in its entirety.

### FIELD

The present disclosure relates to the technical field of compressors, and in particular to a scroll compressor.

### BACKGROUND

As a typical structure of compressors, the scroll compressor is mainly used in air conditioning, refrigeration, general gas compression, as well as in conditions such as automotive engine superchargers and vacuum pumps. The scroll compressor can replace a large range of conventional small and medium-sized reciprocating compressors.

Referring to FIGS. 1 and 2, a typical structure of the scroll compressor includes at least a fix scroll 1, an orbiting scroll 2, and a body 3. Both the fix scroll 1 and the orbiting scroll 2 have scroll shaped blades, which are meshed with each other at an interlocked angle of 180°. The orbiting scroll 2 is driven by an eccentric shaft 4 with a small eccentricity, and is constrained by an anti-rotation mechanism to perform a planar motion around the fix scroll 1 with a small radius, so as to form a series of crescent shaped cylindrical volumes in conjunction with the end plate.

During one revolution of the eccentric shaft 4, the three operation processes of intake, compression, and exhaust of the scroll compressor are performed simultaneously. An intake port 10 is connected to the outer space and the intake process is always performed, an exhaust hole 11 is connected to the inner space and the exhaust process is always performed, and the exhaust hole 11 faces toward an axial direction of the fix scroll 1.

Referring to FIG. 3, the scroll compressor further includes an exhaust valve. The exhaust valve 5 includes an exhaust valve back plate and an exhaust washer. The exhaust valve back plate is fixedly connected to a position of the exhaust hole 11 of the fix scroll 1 by screws, and there is an axial gap between the exhaust valve back plate and the exhaust hole 11. The exhaust washer is located within the axial gap and is configured to block the exhaust hole 11 under an action of internal and external pressure difference during the operation processes of intake and compression, and leave the fix scroll 1 under the action of internal and external pressure difference during the operation process of exhaust and then is stopped by the exhaust valve back plate. In this case, the exhaust hole 11 is opened, and the compressed high-temperature and high-pressure medium is discharged from the exhaust hole 11 until the external pressure is greater than the internal pressure, then the exhaust washer falls back and resets under its own weight and/or pressure difference, and blocks the exhaust hole 11 again.

The scroll compressor further includes an upper cap, which is fixedly connected to the fix scroll 1 and forms an exhaust chamber with the fix scroll. The upper cap is provided with a through hole. In a case that the scroll compressor is in an exhaust condition, the exhaust washer is pushed to open the medium exhaust hole. The compressed high-temperature and high-pressure medium flows through the medium exhaust hole and the medium hole in sequence into the exhaust chamber, and finally flows into an external pipeline through a check valve connected to the exhaust chamber on the upper cap.

The high pressure in the exhaust chamber directly applies on the fix scroll 1. The greater this action force, the greater the deformation of the scroll blade of the fix scroll 1, which is more detrimental to the performance and reliability of the fix scroll 1.

In view of this, those skilled in the art need to find a method to solve the problem in the conventional scroll compressor that the fix scroll is deformed due to the pressure in exhaust chamber applied to the fix scroll.

### SUMMARY

A scroll compressor is provided according to the present disclosure, to solve the problems in the conventional art.

The scroll compressor provided according to the present disclosure includes: a fix scroll, an orbiting scroll, a pressure partition plate, an upper cap, and a pressure relief valve. The orbiting scroll is configured to cooperate with the fix scroll to form a compression chamber with a variable volume. The pressure partition plate is arranged on the fix scroll. The upper cap is connected to the pressure partition plate to form an exhaust chamber. The pressure relief valve is arranged on the pressure partition plate and configured to connect the compression chamber with the exhaust chamber in a case that a pressure in the compression chamber exceeds an exhaust pressure.

In an embodiment, the scroll compressor further includes a connecting piece. The connecting piece is provided with an auxiliary exhaust hole, and the auxiliary exhaust hole of the connecting piece is connected with the compression chamber, and the connecting piece passes through the pressure partition plate and is connected with the exhaust chamber. The pressure relief valve is configured to open or close the auxiliary exhaust hole of the connecting piece based on a relationship between the pressure in the compression chamber and the exhaust pressure.

In an embodiment, the pressure relief valve includes a pressure relief washer, and the pressure relief washer is configured to open the auxiliary exhaust hole of the connecting piece in a case that the pressure in the compression chamber exceeds the exhaust pressure, and close the auxiliary exhaust hole of the connecting piece in a case that the pressure in the compression chamber does not exceed the exhaust pressure.

In an embodiment, the pressure relief valve further includes a pressure relief valve plate, the pressure relief valve plate is arranged on the pressure partition plate and has a through hole, the auxiliary exhaust hole is connected with the exhaust chamber through the through hole, and the pressure relief washer is configured to open or close the through hole.

In an embodiment, the pressure relief valve plate is integrally formed with the pressure partition plate.

In an embodiment, the connecting piece is integrally formed with the fix scroll.

In an embodiment, the scroll compressor further includes a connecting piece. The connecting piece is provided with an auxiliary exhaust hole, the auxiliary exhaust hole of the connecting piece is configured to connect the auxiliary exhaust hole of the fix scroll with the auxiliary exhaust hole of the pressure partition plate, the auxiliary exhaust hole of the fix scroll is connected with the compression chamber, and the auxiliary exhaust hole of the pressure partition plate is connected with the exhaust chamber. The pressure relief valve is configured to open or close the auxiliary exhaust hole of the pressure partition plate based on a relationship between the pressure in the compression chamber and the exhaust pressure.

In an embodiment, the connecting piece is integrally formed with the fix scroll or the pressure partition plate.

In an embodiment, the pressure relief valve includes a pressure relief valve back plate, a pressure relief washer, and a reset spring pre-compressed between the pressure relief valve back plate and the pressure relief washer. The pressure relief washer is configured to overcome an elastic force of the reset spring and connect with the compression chamber with the exhaust chamber in a case that the pressure in the compression chamber exceeds the exhaust pressure.

In an embodiment, the pressure relief valve back plate is further provided with a reset hole connected with the exhaust chamber, and the reset hole is configured to guide the pressure in the exhaust chamber to the pressure relief washer in a case that the pressure in the compression chamber does not exceed the exhaust pressure, to reset the pressure relief washer.

One of the beneficial effects of the scroll compressor of the present disclosure is that the pressure relief valve of the scroll compressor of the present disclosure is arranged on the pressure partition plate, and the high pressure in the exhaust chamber directly applies on the pressure partition plate, rather than directly applying on the fix scroll, thereby reducing the action force on the fix scroll and in turn reducing the risk of deformation of the scroll blade of the fix scroll, thus ensuring the service life, performance, and reliability of the fix scroll.

### BRIEF DESCRIPTION OF THE DRAWINGS

In order to clearly describe the technical solution of the embodiments of the present disclosure, a brief description will be given below to the drawings required for the embodiments. It should be understood that the following drawings only illustrate certain embodiments of the present disclosure and should not be considered as limiting the scope. For those skilled in the art, other relevant drawings may be obtained based on these drawings without any creative work.

FIG. 1 is a schematic sectional view of a partial structure of a scroll compressor;

FIG. 2 is a schematic diagram of a structure in a case that the fix scroll and the orbiting scroll are meshed with each other;

FIG. 3 is a schematic sectional view of a structure of a conventional assembly of a fix scroll and an exhaust valve along an axial direction;

FIG. 4 is a schematic sectional view of a partial structure of a scroll compressor according to an embodiment of the present disclosure;

FIG. 5 is a schematic sectional view of a partial structure of the scroll compressor according to an embodiment of the present disclosure along an axial direction; and

FIG. 6 is a schematic sectional view of a partial structure of the scroll compressor according to an embodiment of the present disclosure along an axial direction.

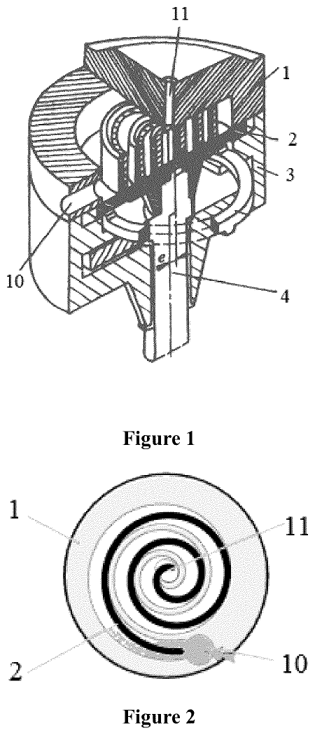

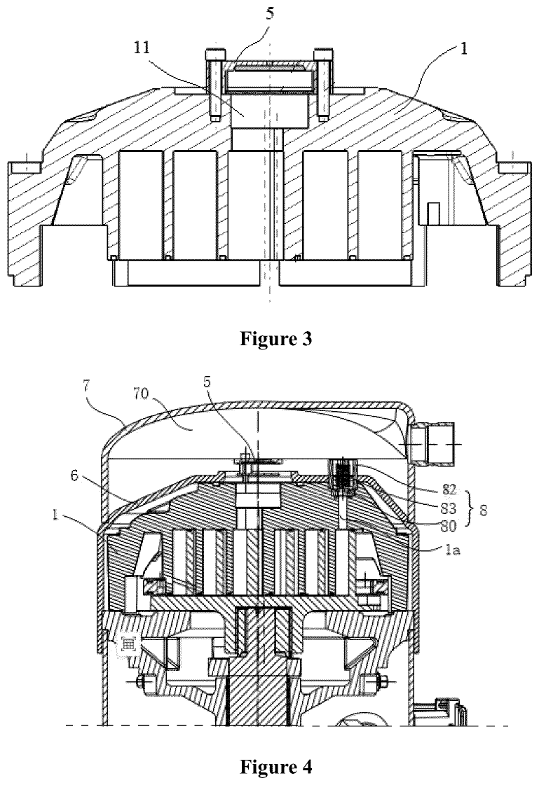

The one-to-one correspondence between names and the reference numbers of components in FIGS. 1 to 6 is described as follows:
1. Fix scroll; 10. Intake port; 11. Exhaust hole; 2. Orbiting scroll; 3. Body; 4. Eccentric shaft; 5. Exhaust valve; 6. Pressure partition plate; 7. Upper cap; 70. Exhaust chamber; 8. Pressure relief valve; 80. Pressure relief washer; 81. Pressure relief valve plate; 82. Pressure relief valve back plate; 820. Pressure relief exhaust hole; 821. Reset hole; 83. Reset spring; 9. Connecting piece; 1a. Auxiliary exhaust hole.

### DETAILED DESCRIPTION OF EMBODIMENTS

Various exemplary embodiments of the present disclosure will now be described in detail with reference to the drawings. It should be noted that the relative arrangement of the components and steps, numerical expressions, and values described in these embodiments do not limit the scope of the present disclosure unless otherwise specified.

The following description of at least one exemplary embodiment is merely illustrative and should not be construed as any limitation on the present disclosure or its application or use.

The techniques, methods, and devices known to those skilled in the art may not be described in detail, but in appropriate circumstances, such techniques, methods, and devices should be considered as a part of the specification.

In all the examples shown and described herein, any specific value should be interpreted as merely illustrative rather than restrictive. Therefore, different values may be used for other examples in the exemplary embodiments.

It should be noted that similar labels and characters represent similar items in the figures. Therefore, once an item is defined in one figure, such item does not need to be further described in subsequent figures.

A scroll compressor is provided according to the present disclosure, which includes a fix scroll, an orbiting scroll, a pressure partition plate, an upper cap, an exhaust valve, and a pressure relief valve. The orbiting scroll is configured to cooperate with the fix scroll to form a compression chamber with a variable volume. The pressure partition plate is arranged on the fix scroll. The upper cap is connected to the pressure partition plate to form an exhaust chamber. The exhaust valve is configured to connect the compression chamber with the exhaust chamber in a case that an exhaust pressure of the compressor is reached. The pressure relief valve is arranged on the pressure partition plate and is configured to connect the compression chamber with the exhaust chamber in a case that the pressure in the compression chamber exceeds the exhaust pressure.

It should be noted that the “medium” herein refers to gases or liquids that may be compressed by a compressor, such as compressed gases, refrigerants. In addition, the exhaust pressure indicates that a pressure in the compression chamber reaches a set pressure allowing for normally exhausting gases to the exhaust chamber, or indicates that a pressure in the compression chamber is in a state that can push the exhaust washer of the exhaust valve, to connect the compression chamber with the exhaust chamber via the exhaust valve, so that the scroll compressor is in a normal exhaust stroke. The exhaust pressure may be a specific value or a value range, depending on factors such as the swept volume of the scroll compressor.

The operating principle of the scroll compressor is described as follows. The orbiting scroll rotates eccentrically around the fix scroll, and the volume of the compression chamber formed by meshing the orbiting scroll and the fix scroll increases on the side of the medium intake hole, creating an internal and external pressure difference of the compression chamber. The medium to be compressed is took into the compression chamber through the medium intake hole, the volume of the compression chamber where the medium is located does not gradually decrease as the orbiting scroll continues to rotate around the fix scroll, so that the medium is compressed. Under the intake and compression conditions, the exhaust valve is always at a position blocking the medium discharge hole and discharge passage. As the temperature and the intensity of pressure of the medium in the compression chamber gradually increase, the exhaust valve connects the medium discharge hole and discharge passage. The high-temperature and high-pressure medium is discharged from the compression chamber through the medium discharge hole and discharged into the exhaust chamber through the discharge passage. Finally, the medium is inputted into devices that use compressed medium such as an air conditioner, through an external pipeline.

In a case that the pressure in the compression chamber of the scroll compressor exceeds the exhaust pressure of the compressor, the pressure relief valve opens the auxiliary exhaust hole under a high pressure, and the compression chamber automatically releases pressure to the exhaust chamber through the auxiliary exhaust hole. The pressure in the compression chamber drops back to near the exhaust pressure, and then the pressure relief valve returns to its original state and closes the auxiliary exhaust hole. The pressure ratio in the compressor decreases and the volume ratio in the compressor changes accordingly to meet the operational needs of the compressor, effectively preventing over compression in the compression chamber of the scroll compressor.

In the conventional technology, the pressure relief valve of the scroll compressor is arranged on the fix scroll, and an upper part of the fix scroll is located in the exhaust chamber. The pressure in the exhaust chamber directly applies on the fix scroll, which can easily cause deformation of the scroll blade of the fix scroll, thereby affecting the performance of the fix scroll.

Compared to the above, in the scroll compressor of the present disclosure, the pressure relief valve is arranged on the pressure partition plate, and a high pressure in the exhaust chamber directly applies on the pressure partition plate, rather than directly applying on the fix scroll, thereby reducing the action force on the fix scroll and in turn reducing the risk of deformation of the scroll blade of the fix scroll, thus ensuring the service life, performance, and reliability of the fix scroll.

For ease of understanding, the specific structure and operating principle of the scroll compressor of the present disclosure will be described in detail with reference to FIGS. 4 to 6 in combination with specific embodiments.

Referring to FIG. 4, in this embodiment, the scroll compressor includes a fix scroll 1, an orbiting scroll 2, a body 3, an exhaust valve 5, a pressure partition plate 6, and an upper cap 7.

The body 3 usually has a shell structure with a thin-wall, and its internal space is sufficient to accommodate the fix scroll 1, the orbiting scroll 2, and the driving mechanism that drives the orbiting scroll 2 to rotate around the fix scroll 1.

Both the fix scroll 1 and the orbiting scroll 2 have scroll shaped blades, which are meshed with each other at an interlocked angle of 180°. The orbiting scroll 2 is driven by a crankshaft with a small eccentricity, and is constrained by an anti-rotation mechanism to perform a planar motion around the fix scroll 1 with a small radius, so as to form a series of crescent shaped cylindrical volumes in conjunction with the end plate.

It should be noted that the specific structure and mutual assembly relationship of the fix scroll 1, the orbiting scroll 2, and the body 3 may be realized by those skilled in the art through the conventional art, and will not be repeated herein.

Continually referring to FIG. 4, in the embodiment, the pressure partition plate 6 is fixedly connected to the fix scroll 1, usually in a manner of welding. However, on the basis of meeting the requirements of manufacturing and assembling, the pressure partition plate 6 may also be fixedly connected to the fix scroll 1 through fasteners such as screws, and other manners such as riveting, or bonding.

The pressure partition plate 6 is provided with a through hole, the through hole is connected with the medium discharge hole of the fix scroll 1, and the through hole and the medium discharge hole are basically coaxial and have the same radius. In this way, the risk of detachment at the connection area between the pressure partition plate 6 and the fix scroll 1 due to the pressure on the pressure partition plate 6 when high-temperature and high-pressure medium is discharged from the compression chamber can be avoided.

A surface of the fix scroll 1 cooperating with the pressure partition plate 6 is provided with a sealing ring groove that surrounds the medium discharge hole. An elastic sealing ring is pressed in the sealing ring groove to achieve stationary sealing between the fix scroll 1 and the pressure partition plate 6, thereby preventing the compressed high-temperature and high-pressure medium from leaking from the surface of the fix scroll 1 cooperating with the pressure partition plate 6.

The upper cap 7 and the pressure partition plate 6 are fixedly connected by welding, bonding, or using fasteners such as screws to form an exhaust chamber 70.

The upper cap 7 is provided with a discharge port connected with the exhaust chamber 70, and the discharge port is connected with an external pipeline. Usually, a check exhaust valve (not shown in the figure) is further arranged on the external pipeline, which is used to prevent refrigerant in the device pipeline of the air conditioner from returning to the scroll compressor, that is, to avoid the commonly called “refrigerant migration”.

The exhaust valve 5 is arranged on the outer surface of the pressure partition plate 6 and is located in the exhaust chamber 70. It should be noted that the directional terms “inside” and “outside” are used herein with reference to the compression chamber, with the inside is a side closer to the compression chamber on the scroll compressor and the outside is a side farther away from the compression chamber on the scroll compressor. The exhaust valve 5 is configured to connect the compression chamber with the exhaust chamber in a case that the exhaust pressure of the compressor is reached.

The pressure relief valve 8 is arranged on the pressure partition plate 6 and is configured to connect the compression chamber with the exhaust chamber 70 in a case that the pressure in the compression chamber exceeds the exhaust pressure.

In this way, in a case that the pressure in the scroll compression chamber exceeds the discharge pressure of the compressor, under the action of the high pressure, the pressure relief valve 8 opens the auxiliary exhaust hole 1a, and the compression chamber automatically releases the pressure to the exhaust chamber 70 through the auxiliary exhaust hole 1a. The pressure in the compression chamber drops back to near the discharge pressure, then the pressure relief valve 8 returns to its original state and closes the auxiliary exhaust hole 1a. The pressure ratio in the compressor decreases, and the volume ratio of the compressor changes accordingly to meet the operational needs of the compressor, thereby effectively preventing over compression in the scroll compression chamber.

In the conventional technology, the pressure relief valve 8 of the scroll compressor is arranged on the fix scroll 1, and an upper part of the fix scroll 1 is located in the exhaust chamber 70. The pressure in the exhaust chamber 70 directly applies on the fix scroll 1, which can easily cause deformation of the scroll blade of the fix scroll 1, affecting the performance of the fix scroll 1.

Compared to the above, in the scroll compressor of the present disclosure, the pressure relief valve 8 is arranged on the pressure partition plate 6, and the high pressure in the exhaust chamber 70 directly applies on the pressure partition plate 6, rather than directly applying the fix scroll 1, thereby reducing the action force on the fix scroll 1 and in turn reducing the risk of deformation of the scroll blade of the fix scroll 1, thus ensuring the service life, performance, and reliability of the fix scroll.

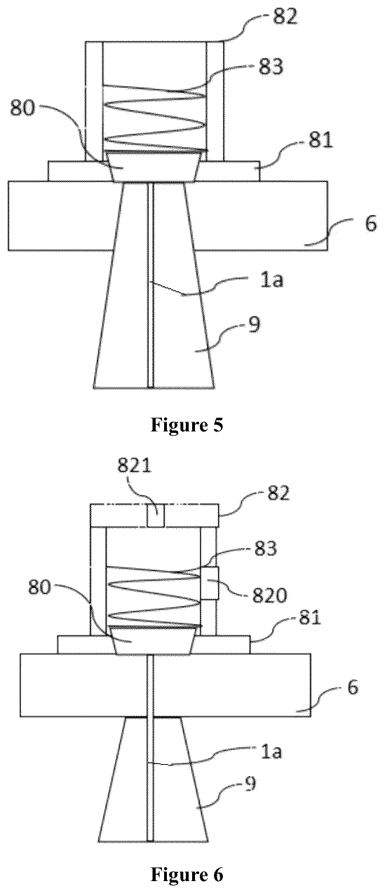

In detail, in an embodiment, referring to FIGS. 4 and 5, the scroll compressor includes a connecting piece 9, which is provided with an auxiliary exhaust hole 1a. The auxiliary exhaust hole 1a of the connecting piece 9 is connected with the compression chamber, and the connecting piece 9 passes through the pressure partition plate 6 and connects with the exhaust chamber 70.

The pressure relief valve 8 is configured to open or close the auxiliary exhaust hole 1a of the connecting piece 9 based on a relationship between the pressure in the compression chamber and the exhaust pressure.

In this way, it is unnecessary to provide the auxiliary exhaust hole 1a on the pressure partition plate 6, only a through hole that may be used for the connecting piece 9 to pass through is provided on the pressure partition plate 6. The size of the through hole is generally larger than that of the auxiliary exhaust hole 1a, thus reducing the difficulty of manufacturing the upper cap 7.

In an embodiment, the connecting piece 9 may be integrally formed with the fix scroll 1, that is, a cylindrical structure is formed on the fix scroll 1 to pass through the pressure partition plate 6, and an auxiliary exhaust hole 1a is formed on the integrally formed structure of the connecting piece 9 and the fix scroll 1 to connect the compression chamber with the exhaust chamber 70.

Further, the connecting piece 9 and the fix scroll 1 of the scroll compressor in the present disclosure are formed independently, and the auxiliary exhaust holes 1a are formed on both of the connecting piece 9 and the fix scroll 1. Then, the connecting piece 9 and the fix scroll 1 are assembled together by welding, bonding, bolt connection, or other ways, and the auxiliary exhaust holes 1a of the connecting piece 9 and the fix scroll 1 are connected with each other, preferably, in a coaxial manner.

Compared with the above structure, the connecting piece 9 and the fix scroll 1 of the scroll compressor of the present disclosure are integrally formed, which not only reduces the number of components in the scroll compressor, but also directly eliminates the steps of independent manufacturing and assembling by integrally forming the auxiliary exhaust hole 1a on the connecting piece 9 and the fix scroll 1, thereby reducing the difficulty of manufacturing and assembling the overall structure.

Continually referring to FIG. 5, in an embodiment, the pressure relief valve 8 of the present disclosure includes a pressure relief washer 80, a pressure relief valve plate 81, a pressure relief valve back plate 82, and a reset spring 83. The pressure relief valve plate 81 is arranged on the pressure partition plate 6 by welding, threaded connection, bonding, or other ways and has a through hole. The auxiliary exhaust hole 1a of the connecting piece 9 is connected with the exhaust chamber 70 through the through hole. The pressure relief valve back plate 82 is fixedly connected to the pressure relief valve plate 81, and the reset spring 83 is pre-compressed between the pressure relief valve back plate 82 and the pressure relief washer 80.

The pressure relief washer 80 is configured to overcome an elastic force of the reset spring 83 in a case that the pressure in the compression chamber exceeds the exhaust pressure, to connect the compression chamber with the exhaust chamber 70 to discharge the gas in the compression chamber into the exhaust valve 5 until the pressure in the compression chamber decreases to or below the exhaust pressure.

That is, in a case that the pressure in the compression chamber does not exceed the exhaust pressure, the pressure relief washer 80 closes the through hole of the pressure relief valve plate 81 under the elastic force of the reset spring 83, that is, closes the exhaust path that connects the compression chamber with the exhaust chamber 70 through the auxiliary exhaust hole 1a.

In an embodiment, the reset spring 83 may be a compression spring or an elastic component that may store elastic potential energy after being compressed, such as a rubber component.

In an embodiment, the pressure relief valve plate 81 may be integrally formed with the pressure partition plate 6.

With the above arrangement, the number of components involved in the scroll compressor of the present disclosure can be reduced, reducing the difficulty of manufacturing and assembling.

That is, the pressure relief valve back plate 82 may be directly fixedly connected to the pressure partition plate 6. In a case that the pressure in the compression chamber does not exceed the exhaust pressure, the pressure relief washer 80 is compressed by the reset spring 83 on the auxiliary exhaust hole 1a of the connecting piece 9. In a case that the pressure in the compression chamber exceeds the exhaust pressure, under the action of the internal and external pressure difference, the pressure relief washer 80 overcomes the elastic force of the reset spring 83 to open the auxiliary exhaust hole 1a of the connecting piece 9, so that the compression chamber and the exhaust chamber 70 are connected with each other through the auxiliary exhaust hole 1a, and the scroll compressor begins to release pressure.

Referring to FIG. 6, in an embodiment, the scroll compressor includes a connecting piece 9, which is provided with an auxiliary exhaust hole 1a. The auxiliary exhaust hole 1a of the connecting piece 9 is connected with the auxiliary exhaust hole 1a of the fix scroll 1 and the auxiliary exhaust hole 1a of the pressure partition plate 6. The auxiliary exhaust hole 1a of the fix scroll 1 is connected with the compression chamber, and the auxiliary exhaust hole 1a of the pressure partition plate 6 is connected with the exhaust chamber 70.

The pressure relief valve 8 is configured to open or close the auxiliary exhaust hole 1a of the pressure partition plate 6 based on a relationship between the pressure in the compression chamber and the exhaust pressure.

In a case that the pressure in the compression chamber exceeds the exhaust pressure, the pressure relief valve 8 opens the auxiliary exhaust hole 1a of the pressure partition plate 6. That is, the compression chamber and the exhaust chamber 70 are connected with each other through the auxiliary exhaust hole 1a of the fix scroll 1, the auxiliary exhaust hole 1a of the connecting piece 9, and the auxiliary exhaust hole 1a of the pressure partition plate 6 in sequence, to quickly release the pressure in the compression chamber into the exhaust chamber 70 to release the pressure, and in a case that the pressure in the compression chamber does not exceed the exhaust pressure, the pressure relief valve closes the auxiliary exhaust hole 1a of the pressure partition plate 6, and the pressure relief is completed.

It should be noted that in this embodiment, the connecting piece 9, the fix scroll 1, and the pressure partition plate 6 are independently formed and then assembled together, and the auxiliary exhaust holes 1a of the connecting piece 9, the fix scroll 1, and the pressure partition plate 6 are connected with each other.

It can be understood that the connecting piece 9 may be integrated with the pressure partition plate 6 to reduce the number of components involved in the scroll compressor of the present disclosure, thereby reducing the difficulty of manufacturing and assembling.

Continually referring to FIG. 6, in this embodiment, the pressure relief valve 8 of the present disclosure includes a pressure relief washer 80, a pressure relief valve plate 81, a pressure relief valve back plate 82, and a reset spring 83. The pressure relief valve plate 81 is arranged on the pressure partition plate 6 by welding, threaded connection, bonding, or other ways and has a through hole. The auxiliary exhaust hole 1a of the pressure partition plate 6 is connected with the exhaust chamber 70 through the through hole. The pressure relief valve back plate 82 is fixedly connected to the pressure relief valve plate 81, and the reset spring 83 is pre-compressed between the pressure relief valve back plate 82 and the pressure relief washer 80. The pressure relief washer 80 is configured to overcome the elastic force of the reset spring 83 to connect the compression chamber with the exhaust chamber 70 in a case that the pressure in the compression chamber exceeds the exhaust pressure, to discharge the gas in the compression chamber into the exhaust valve 5 until the pressure in the compression chamber decreases to or below the exhaust pressure.

That is, in a case that the pressure in the compression chamber does not exceed the exhaust pressure, the pressure relief washer 80 closes the through hole of the pressure relief valve plate 81 under the elastic force of the reset spring 83, that is, closes the exhaust path that connects the compression chamber with the exhaust chamber 70 through the auxiliary exhaust hole 1a.

In an embodiment, the reset spring 83 may be a compression spring or an elastic component that can store elastic potential energy after being compressed, such as a rubber component.

In an embodiment, the pressure relief valve plate 81 may be integrally formed with the pressure partition plate 6, as shown in the structure in FIG. 4.

With this arrangement, the number of components involved in the scroll compressor of the present disclosure can be reduced, thereby reducing the difficulty of manufacturing and assembling.

That is, the pressure relief valve back plate 82 may be directly fixedly connected to the pressure partition plate 6. In a case that the pressure in the compression chamber does not exceed the exhaust pressure, the pressure relief washer 80 is compressed by the reset spring 83 onto the auxiliary exhaust hole 1a on the pressure partition plate 6. In a case that the pressure in the compression chamber exceeds the exhaust pressure, under the action of the internal and external pressure difference, the pressure relief washer 80 overcomes the elastic force of the reset spring 83 to open the auxiliary exhaust hole 1a of the pressure partition plate 6, so that the compression chamber and the exhaust chamber 70 are connected with each other through the auxiliary exhaust hole 1a. The scroll compressor begins to release pressure until the pressure in the compression chamber does not exceed the exhaust pressure, and then the pressure relief washer 80 closes the auxiliary exhaust hole 1a on the pressure partition plate 6, thus the pressure relief is completed.

Further, in order to ensure the smooth reset of the pressure relief washer 80, continually referring to FIG. 6, the pressure relief valve back plate 82 of the present disclosure is also provided with a reset hole 821 connected with the exhaust chamber 70, and the reset hole 821 is configured to guide the pressure in the exhaust chamber 70 to the pressure relief washer 80 in a case that the pressure in the compression chamber does not exceed the exhaust pressure, so as to reset the pressure relief washer 80.

That is, in this embodiment, the pressure relief washer 80 may be reset through the action of both the reset spring 83 and the pressure from the reset hole 821.

With this arrangement, the problem of unable to reset due to the reset spring 83 failing or the pressure relief washer 80 being stuck on the pressure relief valve back plate 82 can be avoided, thereby avoiding the problem of airflow of the exhaust chamber 70 flowing back into the compression chamber during the compression, intake and other operating strokes of the scroll compressor, thus ensuring the normal and safe operation of the compressor.

In detail, in this embodiment, the reset hole 821 is provided on the pressure relief valve back plate 82 at a side opposite to the pressure relief washer 80, that is, on a top plate of the pressure relief valve back plate 82, so that the air pressure introduced into the exhaust chamber 70 can be fully applied on the pressure relief washer 80 and the pressure relief washer 80 can be reset quickly.

Moreover, in order to release the pressure in the compression chamber to the exhaust chamber 70 under the pressure relief condition, in this embodiment, the pressure relief exhaust hole 820 of the pressure relief valve back plate 82 is arranged on a side plate of the pressure relief valve back plate 82, preferably within the minimum stroke range of the pressure relief washer 80.

It should be noted that the solution of arranging a reset hole 821 on the pressure relief valve back plate 82 in this embodiment is also applicable to the embodiment shown in FIG. 5, which can be fully understand and implemented based on the above description by those skilled in the art, and will not be repeated here.

However, in the embodiments shown in FIGS. 5 and 6, the pressure relief valve 8 of the present disclosure may only include a pressure relief washer 80, which may be an elastic plate fixed to the pressure partition plate 6 by bolt connection or other ways and can block the auxiliary exhaust hole 1a of the pressure partition plate 6 or the connecting piece 9 under an action of its own elastic potential energy. In a case that the pressure in the compression chamber exceeds the exhaust pressure, the pressure relief washer 80 overcomes the resistance of its own elastic potential energy and deforms away from the pressure partition plate 6 under the action of the internal and external pressure difference, so that the auxiliary exhaust hole 1a of the pressure partition plate 6 is connected with the exhaust chamber 70, and the compression chamber is connected with the exhaust chamber 70, thus pressure relief is started. In a case that the pressure in the compression chamber decreases to no longer exceed the exhaust pressure, the internal and external pressure difference decreases, and the pressure relief washer 80 resets under the action of its own elastic potential energy to block the auxiliary exhaust hole 1a again, so that the compression chamber is not connected with the exhaust chamber 70, thus the pressure relief is completed.

It can be understood that this pressure relief valve has a simple structure and is easy to implement. This pressure relief valve achieve the purpose of blocking the auxiliary exhaust hole 1a by using its own elastic potential energy. However, this pressure relief washer 80 may be provided with a pressure relief valve plate 81, while components such as the reset spring 83 and the pressure relief valve back plate 82 are not required.

Various embodiments of the present disclosure have been described above, and the foregoing description is exemplary and not exhaustive, and is not limited to the disclosed embodiments. Many modifications and changes made without departing from the scope and spirit of the disclosed embodiments will be apparent to those skilled in the art. The terms used herein is chosen to best explain the principles of the embodiments, practical applications, or improvements to techniques in the marketplace, or to enable others of ordinary skill in the art to understand the embodiments disclosed herein. The scope of the present disclosure is limited by the claims.

1. A scroll compressor, comprising:
a fix scroll;
an orbiting scroll, configured to cooperate with the fix scroll to form a compression chamber with a variable volume;
a pressure partition plate, arranged on the fix scroll;
an upper cap, connected to the pressure partition plate to form an exhaust chamber; and
a pressure relief valve, arranged on the pressure partition plate and configured to connect the compression chamber with the exhaust chamber in a case that a pressure in the compression chamber exceeds an exhaust pressure.

2. The scroll compressor according to claim 1, further comprising a connecting piece, wherein the connecting piece is provided with an auxiliary exhaust hole, and the auxiliary exhaust hole of the connecting piece is connected with the compression chamber, and the connecting piece passes through the pressure partition plate and is connected with the exhaust chamber; and
the pressure relief valve is configured to open or close the auxiliary exhaust hole of the connecting piece based on a relationship between the pressure in the compression chamber and the exhaust pressure.

3. The scroll compressor according to claim 2, wherein the pressure relief valve comprises a pressure relief washer, and the pressure relief washer is configured to open the auxiliary exhaust hole of the connecting piece in a case that the pressure in the compression chamber exceeds the exhaust pressure, and close the auxiliary exhaust hole of the connecting piece in a case that the pressure in the compression chamber does not exceed the exhaust pressure.

4. The scroll compressor according to claim 3, wherein the pressure relief valve further comprises a pressure relief valve plate, the pressure relief valve plate is arranged on the pressure partition plate and has a through hole, the auxiliary exhaust hole is connected with the exhaust chamber through the through hole, and the pressure relief washer is configured to open or close the through hole.

5. The scroll compressor according to claim 4, wherein the pressure relief valve plate is integrally formed with the pressure partition plate.

6. The scroll compressor according to claim 2, wherein the connecting piece is integrally formed with the fix scroll.

7. The scroll compressor according to claim 1, further comprising:
a connecting piece, provided with an auxiliary exhaust hole, wherein the auxiliary exhaust hole of the connecting piece is configured to connect the auxiliary exhaust hole of the fix scroll with the auxiliary exhaust hole of the pressure partition plate, the auxiliary exhaust hole of the fix scroll is connected to the compression chamber, and the auxiliary exhaust hole of the pressure partition plate is connected with the exhaust chamber, and
the pressure relief valve is configured to open or close the auxiliary exhaust hole of the pressure partition plate based on a relationship between the pressure in the compression chamber and the exhaust pressure.

8. The scroll compressor according to claim 7, wherein the connecting piece is integrally formed with the fix scroll or the pressure partition plate.

9. The scroll compressor according to claim 1, wherein the pressure relief valve comprises a pressure relief valve back plate, a pressure relief washer, and a reset spring pre-compressed between the pressure relief valve back plate and the pressure relief washer; and
the pressure relief washer is configured to overcome an elastic force of the reset spring to connect the compression chamber with the exhaust chamber in a case that the pressure in the compression chamber exceeds the exhaust pressure.

10. The scroll compressor according to claim 9, wherein the pressure relief valve back plate is further provided with a reset hole connected with the exhaust chamber, and the reset hole is configured to guide the pressure in the exhaust chamber to the pressure relief washer in a case that the pressure in the compression chamber does not exceed the exhaust pressure, to reset the pressure relief washer.
